(19) United States
(12) Patent Application Publication
(10) Pub. No.: US 2016/0095154 A1
(43) Pub. Date: Mar. 31, 2016

(54) Methods and Apparatus for Handling Connections to Multiple Radio Access Technologies

(71) Applicant: TELEFONAKTIEBOLAGET L M ERICSSON (PUBL), Stockholm (SE)

(72) Inventors: Håkan Palm, Växjö (SE); Niklas Johansson, Sollentuna (SE); Mattias Tan Bergström, Stockholm (SE); Oumer Teyeb, Solna (SE); Yu Wang, Solna (SE)

(21) Appl. No.: 14/892,125

(22) PCT Filed: May 13, 2014
(86) PCT No.: PCT/SE2014/050582

§ 371 Date: Nov. 18, 2015

Related U.S. Application Data
(60) Provisional application No. 61/826,675, filed on May 23, 2013.

(51) Int. Cl. H04W 76/02; H04W 74/08; H04W 48/18

(52) U.S. Cl. CPC H04W 76/026; H04W 48/18; H04W 74/0833; H04W 88/06

(57) ABSTRACT

An example method includes a mobile terminal attempting to connect (1020) to a first radio access network, RAN, operating according to a first radio access technology, RAT. The attempt to connect may be a random access attempt. The method further comprises the mobile terminal indicating (1030), to the first RAN, as part of the connection attempt, a connection status for the mobile terminal with respect to a second RAN operating according to a second RAT. In various embodiments, this indicating may comprise indicating whether the mobile terminal is connected to the second RAN, whether the mobile terminal has access rights to connect to the second RAN, or whether the mobile terminal has detected the second RAN. The first RAN may determine whether or not to grant the mobile terminal access based on the indication of connection status from the mobile terminal.

### TECHNICAL FIELD

The present disclosure is generally related to wireless devices that support multiple radio access technologies and more particularly relates to the handling of connections to multiple radio access technologies in these devices.

### BACKGROUND

The wireless local-area network (WLAN) technology known as “W-Fi” has been standardized by IEEE in the 802.11 series of specifications (i.e., as “IEEE Standard for Information technology—Telecommunications and information exchange between systems. Local and metropolitan area networks—Specific requirements. Part 11: Wireless LAN Medium Access Control (MAC) and Physical Layer (PHI) Specifications”). As currently specified, Wi-Fi systems are primarily operated in the 2.4 GHz or 5 GHz bands.

The IEEE 802.11 specifications regulate the functions and operations of the Wi-Fi access points or wireless terminals, collectively known as “stations” or “STA,” in the IEEE 802.11, including the physical layer protocols, Medium Access Control (MAC) layer protocols, and other aspects needed to secure compatibility and inter-operability between access points and portable terminals. Because Wi-Fi is generally operated in unlicensed bands, communication over Wi-Fi may be subject to interference sources from any number of both known and unknown devices. Wi-Fi is commonly used as a wireless extension to fixed broadband access, e.g., in domestic environments and in so-called hotspots, such as airports, train stations and restaurants.

Recently, Wi-Fi has been subject to increased interest from cellular network operators, who are studying the possibility of using Wi-Fi for purposes beyond its conventional role as an extension to fixed broadband access. These operators are responding to the ever-increasing market demands for wireless bandwidth, and are interested in using Wi-Fi technology as an extension of, or alternative to, cellular radio access network technologies. Cellular operators that are currently serving mobile users with, for example, any of the technologies standardized by the 3^{rd}-Generation Partnership Project (3GPP), including the radio-access technologies known as Long-Term Evolution (LTE), Universal Mobile Telecommunications System/Wideband Code-Division Multiple Access, and Global System for Mobile Communications (GSM), see Wi-Fi as a wireless technology that can provide good additional support for users in their regular cellular networks.

As used herein, the term “operator-controlled Wi-Fi” indicates a Wi-Fi deployment that on some level is integrated with a cellular network operator's existing network, where the operator's radio access network(s) and one or more Wi-Fi wireless access points may even be connected to the same core network and provide the same or overlapping services. Currently, several standardization organizations are intensely active in the area of operator-controlled Wi-Fi. In 3GPP, for example, activities to connect W-Fi access points to the 3GPP-specified core network are being pursued. In the W-Fi alliance (WFA), activities related to certification of W-Fi products are undertaken, which to some extent are also driven from the need to make W-Fi a viable wireless technology for cellular operators to support high bandwidth offerings in their networks. In these standardization efforts, the term “Wi-Fi offload” is commonly used, indicating that cellular network operators seek means to offload traffic from their cellular networks to W-Fi, e.g., during peak-traffic-hours and in situations when the cellular network needs to be off-loaded for one reason or another, e.g., to provide a requested quality-of-service, to maximize bandwidth, or simply for improved coverage.

For a wireless operator, offering a mix of two technologies that have been standardized in isolation from each other raises the challenge of providing intelligent mechanisms for co-existence. One area that needs these intelligent mechanisms is connection management.

Many of today's portable wireless devices (referred to hereinafter as “user equipment,” or “UEs”) support W-Fi in addition to one or sever al 3GPP cellular technologies. In many cases, however, these terminals essentially behave as two separate devices, from a radio access perspective. The 3GPP radio access network and the UE-based modems and protocols that are operating pursuant to the 3GPP specifications are generally unaware of the wireless access Wi-Fi protocols and modems that may be simultaneously operating pursuant to the 802.11 specifications. Techniques for coordinated control of these multiple radio-access technologies are needed. In particular, improved methods and apparatus are needed for network control of terminals' connections when both a cellular network and a WLAN are available.

### SUMMARY

More and more terminals are capable of connecting to and obtaining service from both a WLAN and a 3GPP RAT, such as WCDMA and LTE. In a system where some terminals can connect to WLAN and some terminals cannot (due to differences in capabilities, due to being inside/outside the coverage of a WLAN access point), it is likely to be preferred that the terminals that cannot connect to a WLAN or that are not currently connected to a WLAN should be given priority with respect to accessing the LTE network over those terminals that can connect to a WLAN or that are already connected to a WLAN. This may be especially important when the LTE network can only admit a limited number of terminals, for example due to high load.

According to several embodiments of the presently disclosed techniques, a terminal indicates to a first radio access network (RAT) whether the terminal is connected to or is able to connect to a second RAT. The first RAT then takes this into consideration and may prioritize a terminal indicating that it is not connected to another RAT over a terminal that is connected to another RAT.

Embodiments of the presently disclosed techniques include methods for implementation in a mobile terminal configured to operate according to two or more radio access technologies (RATs). An example method includes attempting to connect to a first radio access network (RAN) operating according to a first RAT. The attempt to connect may be, for example, a random access attempt. The example method further comprises indicating, to the first RAN, as part of the connection attempt, a connection status for the mobile terminal with respect to a second RAN operating according to a second RAT. In some embodiments, this indicating comprises indicating whether or not the mobile terminal is connected to the second RAN. In other embodiments, this indicating comprises indicating whether or not the mobile terminal has access rights to connect to the second RAN. In some embodiments, indicating the connection status for the mobile terminal comprises indicating that the mobile terminal has detected the second RAN.

Other embodiments include corresponding methods for implementation in a base station or other node of a first radio access network (RAN) operating according to a first radio access technology (RAT). An example method begins with receiving, in association with a mobile terminal attempting to connect to the first RAN, an indication of a connection status for the mobile terminal with respect to a second RAN operating according to a second RAT. The example method continues with determining whether or not to grant the mobile terminal access to the first RAN, based on the indication. In some embodiments, determining whether or not to grant the mobile terminal access to the first RAN comprises prioritizing the mobile terminal for access, based on the indication. In some embodiments or instances, determining whether or not to grant the mobile terminal access to the first RAN comprises rejecting access to the mobile terminal, based on the indication. In some embodiments, rejecting access to the mobile terminal may be further based on a loading condition for the first RAN.

Corresponding mobile terminal apparatus and base station apparatus are described in detail below.

### BRIEF DESCRIPTION OF THE FIGURES

In the attached figures:

FIG. 1 illustrates the overall E-UTRAN architecture;

FIG. 2 illustrates the user plane architecture for a Wi-Fi network;

FIG. 3 illustrates the control plane architecture for a Wi-Fi network;

FIG. 4 illustrates a baseline scenario in which Wi-Fi is not integrated with a mobile network;

FIG. 5 illustrates several problems arising with the use of “W-Fi-if-coverage” access selection;

FIG. 6 illustrates user plane integration of Wi-Fi and a mobile network;

FIG. 7 illustrates an example allocation of uplink resources for random-access preamble transmission;

FIG. 8 is a signaling flow diagram illustrating a random access procedure in LTE;

FIG. 9 illustrates contention issues with random access procedures in LTE;

FIG. 10 is a process flow diagram illustrating an example method, in a mobile terminal, for carrying out some of the presently disclosed techniques.

FIG. 11 is a process flow diagram illustrating an example method, in a base station, for carrying out others of the presently disclosed techniques.

FIG. 12 is a block diagram illustrating an example mobile terminal apparatus adapted to carry out one or more of the techniques detailed herein.

FIG. 13 is a block diagram illustrating an example base station apparatus adapted to carry out one or more of the techniques detailed herein.

### DETAILED DESCRIPTION

In the discussion that follows, specific details of particular embodiments of the present invention are set forth for purposes of explanation and not limitation. It will be appreciated by those skilled in the art that other embodiments may be employed apart from these specific details. Furthermore, in some instances detailed descriptions of well-known methods, nodes, interfaces, circuits, and devices are omitted so as not obscure the description with unnecessary detail. Those skilled in the art will appreciate that the functions described may be implemented in one or in several nodes. Some or all of the functions described may be implemented using hardware circuitry, such as analog and/or discrete logic gates interconnected to perform a specialized function, ASICs, PLAs, etc. Likewise, some or all of the functions may be implemented using software programs and data in conjunction with one or more digital microprocessors or general purpose computers. Where nodes that communicate using the air interface are described, it will be appreciated that those nodes also have suitable radio communications circuitry. Moreover, the technology can additionally be considered to be embodied entirely within any form of computer-readable memory, including non-transitory embodiments such as solid-state memory, magnetic disk, or optical disk containing an appropriate set of computer instructions that would cause a processor to carry out the techniques described herein.

Hardware implementations of the present invention may include or encompass, without limitation, digital signal processor (DSP) hardware, a reduced instruction set processor, hardware (e.g., digital or analog) circuitry including but not limited to application specific integrated circuit(s) (ASIC) and/or field programmable gate array(s) (FPGA(s)), and (where appropriate) state machines capable of performing such functions.

In terms of computer implementation, a computer is generally understood to comprise one or more processors or one or more controllers, and the terms computer, processor, and controller may be employed interchangeably. When provided by a computer, processor, or controller, the functions may be provided by a single dedicated computer or processor or controller, by a single shared computer or processor or controller, or by a plurality of individual computers or processors or controllers, some of which may be shared or distributed. Moreover, the term “processor” or “controller” also refers to other hardware capable of performing such functions and/or executing software, such as the example hardware recited above.

The discussion that follows frequently refers to “mobile terminals,” “terminals,” or “UEs,” the latter of which is the 3GPP term for end user wireless devices. It should be appreciated, however, that the techniques and apparatus described herein are not limited to 3GPP UEs, but are more generally applicable to end-user wireless devices (e.g., portable cellular telephones, smartphones, wireless-enabled tablet computers, etc.) that are useable in cellular systems. It should also be noted that the current disclosure relates to end-user wireless devices that support both a wireless local area network (WLAN) technology, such as one or more of the IEEE 802.11 standards, and a wide-area cellular technology, such as any of the wide-area radio access standards maintained by 3GPP or other wide-area radio access standards such as WiMAX. End-user devices are referred to in Wi-Fi document as “stations,” or “STA”—it should be appreciated that the term “UE” as used herein should be understood to refer to a STA, and vice-versa, unless the context clearly indicates otherwise.

Some embodiments of the techniques and apparatus disclosed herein are described in the context of a wireless network operating according to one or more of the standards developed by 3GPP, although the inventive techniques disclosed herein are not limited to that context. It will be appreciated that while details of one type of 3GPP network, namely, those networks commonly referred to as Long-Term Evolution (LTE) networks, are provided below, the techniques disclosed herein may be adapted to other 3GPP networks, including those based on standards for GSM and/or W-CDMA.

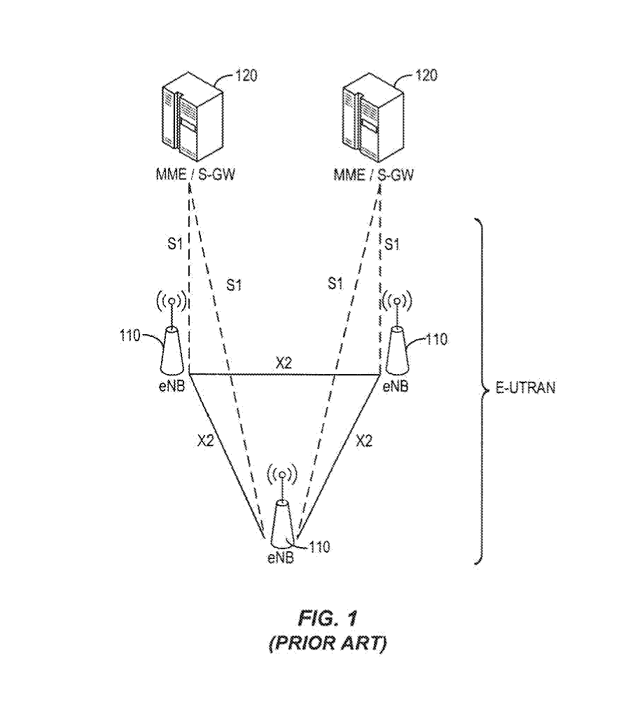

The Evolved UMTS Terrestrial Radio Access Network (E-UTRAN), commonly referred to as the LTE network, consists of base stations called enhanced NodeBs (eNBs or eNodeBs), which provide the E-UTRA user plane and control plane protocol terminations towards the User Equipment (UE). The eNBs are interconnected with each other by means of the X2 interface. The eNBs are also connected by means of the S1 interface to the EPC (Evolved Packet Core), more specifically to the MME (Mobility Management Entity), by means of the S1-MME interface, and to the Serving Gateway (S-GVV) by means of the S1-U interface. The S1 interface supports many-to-many relations between MMES/S-GWs and eNBs. FIG. 1 provides a simplified view of the E-UTRAN, as well as components of the Evolved Packet Core (EPC), which provides interconnectivity between the E-UTRAN and public data networks.

As seen in FIG. 1, eNBs 110 communicate with one another by means of the X2 interface, which is defined by a set of communications protocols described by the 3GPP document “Evolved Universal Terrestrial Radio Access Network (E-UTRAN); X2 General Aspects and Principles,” 3GPP TS 36.420, v. 11.0.0 (September 2012). The X2 is an IP interface using Stream Control Transmission Protocol (SCTP) as a transport layer. The eNBs 110 are also connected by means of the S1 interface to the EPC, more specifically to MMEs (Mobility Management Entities) 120 by means of the S1-MME interface and to the Serving Gateway (S-GW, not shown in FIG. 1) by means of the S1-U interface. The S1 interface is described in the 3GPP document “Evolved Universal Terrestrial Radio Access Network (E-UTRAN); S1 General Aspects and Principles,” 3GPP TS 36.410, v. 11.0.0 (September 2012). The S1 interface supports many-to-many relation between MMEs/S-GWs and eNBs.

The eNBs 110 host functionalities such as Radio Resource Management (RRM), radio bearer control, admission control, header compression of user plane data towards serving gateway, routing of user plane data towards the serving gateway. MMEs 120 are the control nodes that process the signaling between the UE and the core network (CN). The main functions of the MME 120 are related to connection management and bearer management, which are handled via Non Access Stratum (NAS) protocols. The Serving Gateway (S-GVV) is the anchor point for UE mobility, and also includes other functionalities such as temporary downlink data buffering while the UE is being paged, packet routing and forwarding of data to the right eNB, gathering of information for charging and lawful interception, etc. The PDN Gateway (P-GVV) is the node responsible for IP address allocations to UEs, as well as Quality-of-Service (QoS) enforcement.

As noted above, operators of wide-area wireless networks are increasingly interested in the use of Wi-Fi/WLAN (the two terms are used interchangeably throughout this document) to offload traffic from the mobile networks. Increased cooperation between Wi-Fi and mobile networks offer benefits from the end user's point of view as well. Some of the potential advantages are as follows:
Additional frequency: by using Wi-Fi, operators can access an additional 85 MHz of radio bandwidth in the 2.4 GHz band and another (close to) 500 MHz in the 5 GHz band.
Cost: From the operator's point of view, W-Fi uses unlicensed frequency that is free of charge. On top of that, the cost of W-Fi Access Points (APs), both from capital expense (CAPEX) and operational expenses (OPEX) aspects, is considerably lower than that of a 3GPP base station (BS/eNB). Operators can also take advantage of already deployed APs that are already deployed in hotspots such as train stations, airports, stadiums, shopping malls, etc. Most end users are also currently used to having W-Fi for free at home (as home broadband subscriptions are usually flat rate) and public places.
Terminal support: Many User Equipments (UEs), including virtually all smartphones, and other portable devices currently available in the market support Wi-Fi. In the W-Fi world, the term Station (STA) is used instead of UE, and as such the terms UE, STA and terminal are used interchangeably in this document.
High data rate: Under low interference conditions and assuming the user is close to the Wi-Fi AP, W-Fi can provide peak data rates that outshine that of current mobile networks (for example, theoretically up to 600 Mbps for IEEE 802.11n deployments with MIMO (Multiple Input Multiple Output)).

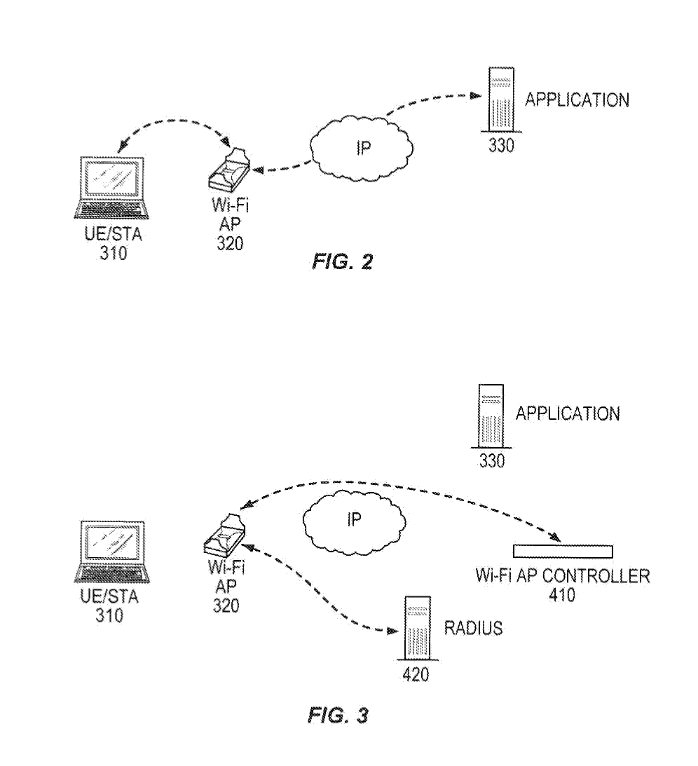

A very simplified W-Fi architecture is illustrated in FIG. 2 and FIG. 3, which illustrate the user plane and control plane architectures, respectively. On the user plane (FIG. 2), a very lean architecture is employed, where the UE/STA 310 is connected to the Wi-Fi Access Point (AP) 320, which can directly be connected to the Internet, providing the UE/STA 310 with access to applications provided by an application server 330. In the control plane (FIG. 3), an Access point Controller (AC) 410 handles the management of the AP. One AC usually handles the management of several APs. Security/authentication of users is handled via an Authentication, Authorization and Accounting (AAA) entity, which is shown as a RADIUS server 420 in FIG. 3. Remote Administration Dial In User Service (RADIUS) is the most widely used network protocol for providing a centralized AAA management (RFC 2865).

Different standards organizations have started to recognize the needs for an enhanced user experience for W-Fi access, this process being driven by 3GPP operators. An example of this is the W-Fi Alliance with the Hot-Spot 2.0 (HS2.0) initiative, now officially called PassPoint (“Hotspot 2.0 (Release 1) Technical Specification”, W-Fi Alliance® Technical Committee Hotspot 2.0 Technical Task Group, V 1.0.0). HS2.0 is primarily geared toward Wi-Fi networks. HS2.0 builds on IEEE 802.11u, and adds requirements on authentication mechanisms and auto-provisioning support.

The momentum of Hot-Spot 2.0 is due to its roaming support, its mandatory security requirements and for the level of control it provides over the terminal for network discovery and selection. Even if the current release of HS2.0 is not geared toward 3GPP interworking, 3GPP operators are trying to introduce additional traffic steering capabilities, leveraging HS2.0 802.11u mechanisms. Because of the high interest of 3GPP operators, there will be a second release of HS2.0 focusing on 3GPP interworking requirements.

HS2.0 contains the following procedures:
1 Discovery: where the terminal discovers the Wi-Fi network, and probes it for HS2.0 support, using 802.11u and HS 2.0 extensions.
2 Registration is performed by the terminal toward the Wi-Fi Hot-spot network if there is no valid subscription for that network.
3 Provisioning: Policy related to the created account is pushed toward the terminal. This only takes place when a registration takes place.
4 Access: cover the requirements and procedures to associate with a HS2.0 Wi-Fi network.

One of the attractive aspects of HS2.0 is that it provides information for the STA that can be used to evaluate the load of the Wi-Fi network before attempting the authentication process, thereby avoiding unnecessary connections to highly loaded Wi-Fi network.

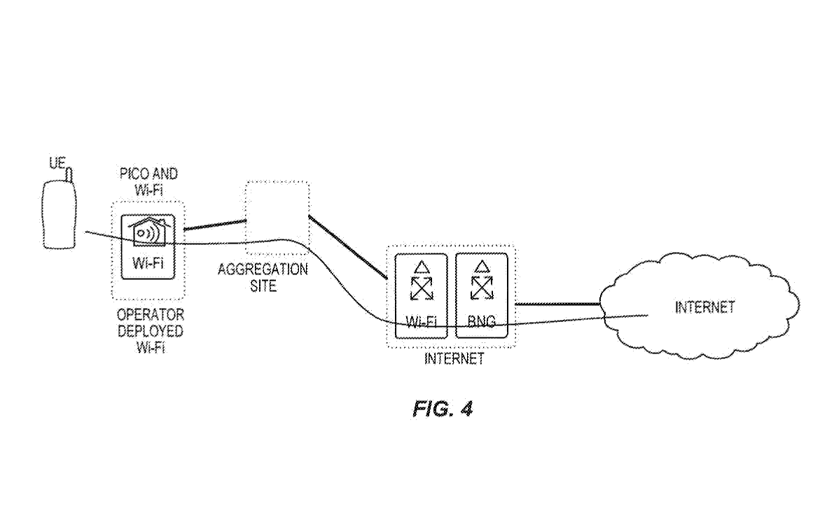

Most current Wi-Fi deployments are totally separate from mobile networks, and thus regarded as non-integrated. This baseline approach to Wi-Fi deployment is shown in FIG. 4, which shows a scenario in which the Wi-Fi network is not integrated with a mobile terminal. From the terminal perspective, most mobile operating systems (OS) for UEs such as Android and ioS, support a simple Wi-Fi offloading mechanism, where the UEs immediately switch all their PS (Packet Switched) bearers to a Wi-Fi network upon a detection of such a network with a certain signal level. The decision to offload to a Wi-Fi or not is referred henceforth as access selection strategy and the aforementioned strategy of selecting Wi-Fi whenever such a network is detected is known as “Wi-Fi-if-coverage”.

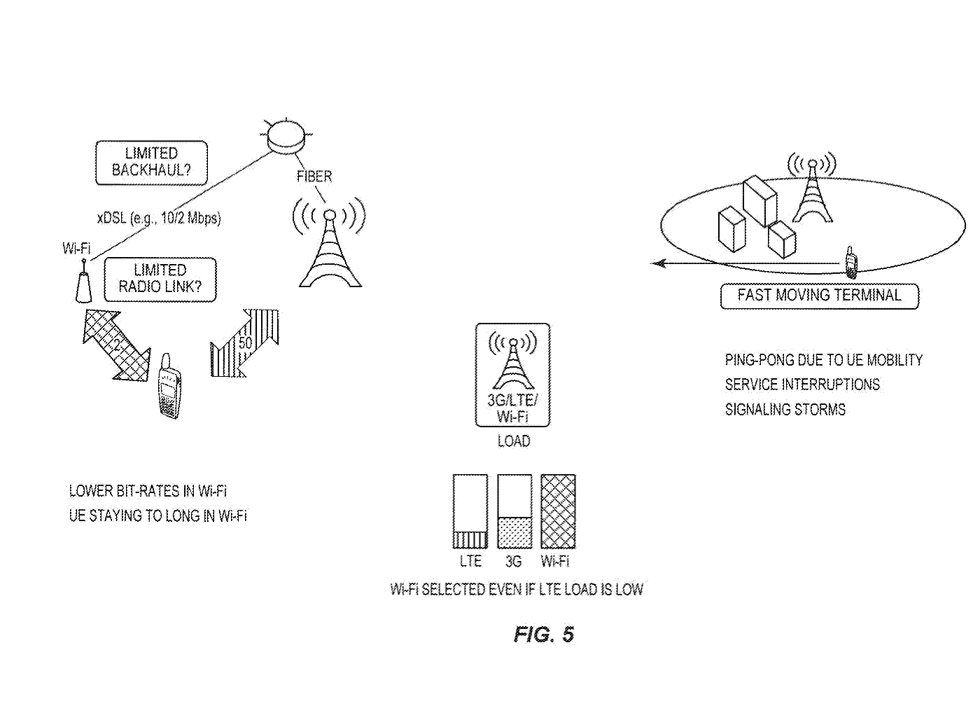

There are several drawbacks of the W-Fi-if-coverage strategy. Some of these are shown in FIG. 5. First, although the user/UE can save previous passocdes for already accessed Wi-Fi Access Points (APs), hotspot login for previously unaccessed APs usually requires user intervention, either by entering the passcode in Wi-Fi connection manager or using a web interface. Second, interruptions of ongoing services can occur due to the change of IP address when the UE switches to the Wi-Fi network. For example, a user who started a VoIP call while connected to a mobile network is likely to experience call drop when arriving home and the UE switching to the Wi-Fi network automatically. Though some applications are smart enough to handle this and to survive the IP address change (e.g., Spotify), the majority of current applications cannot. It also places a lot of burden on application developers if they have to ensure service continuity.

Third, no consideration of expected radio performance is made, which can lead to a UE being handed over from a high data rate mobile network link to a low data rate via the Wi-Fi link. Even though the UE's OS or some high-level software is smart enough to make the offload decisions only when the signal level on the Wi-Fi is considerably better than the mobile network link, there can still be limitations on the backhaul that the Wi-Fi AP is using that may end up being the bottle neck. Fourth, no consideration of the load conditions in the mobile network and Wi-Fi are made. As a result, the UE might still be offloaded to a Wi-Fi AP that is serving several UEs while the mobile network (e.g., LTE) that it was previously connected to is rather unloaded.

Finally, no consideration of the UE's mobility is made. Due to this, a fast moving UE can end up being offloaded to a Wi-Fi AP for a short duration, just to be handed back over to the mobile network. This is especially a problem in scenarios such as cafes with open where a user walking by or even driving by the cafe might be affected by this. Such ping-ponging between the Wi-Fi and mobile network can cause service interruptions, and can generate considerable unnecessary signaling (e.g. towards authentication servers).

In order to combat these problems, several Wi-Fi/3GPP integration mechanisms have been proposed. One of these is known as “common authentication,” while another can be referred to as “user plane integration.”

Common authentication is based on the use of automatic SIM-based authentication in both access types, i.e., in both mobile network accesses (such as to a 3GPP network) and WLAN accesses. Extensible Authentication Protocol (EAP) is an authentication framework that provides support for the different authentication methods. Described by RFC 3748 and later updated by RFC 5247, this protocol is carried directly over data-link layer (DLL) and is currently widely deployed in WLANs. The EAP framework specifies over forty different methods for authentication, and EAP-SIM (Subscriber Identity Module) is the one that is becoming widely available in UEs and networks. A key benefit of common authentication is that the user doesn't necessarily have to be actively involved in the authentication process, which will increase the chances of more traffic to be steered to the Wi-Fi side, paving the way for network centric control.

Wi-Fi user plane integration provides the mobile operator the opportunity to provide the same services, like parental control and subscription based payment methods, for the end users when connected both via 3GPP and via The solutions also include the possibility to offload parts of the user plane from the mobile core so that not all traffic needs to be brought to the mobile core network.

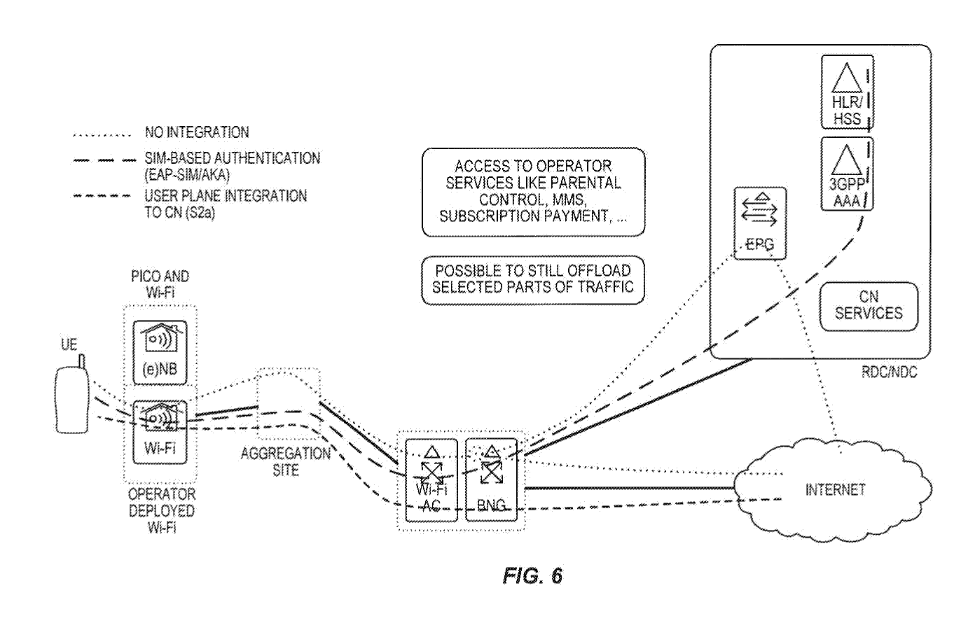

Different solutions are being standardized in 3GPP. Overlay solutions (S2b, S2c) are specified since 3GPP Rel-8, while integration solutions (S2a) are currently a work-in-progress (S2a, S2b, S2c indicate the 3GPP interface/reference point name towards the PDN-GW). FIG. 6 shows a high level view of user plane integration.

A further level of integration can be realized via access selection based on RAN information on both 3GPP and Wi-Fi, in addition to the common authentication and user plane integration methods discussed above. With this approach, a functional entity known as a Smart RAN Controller (SRC) is introduced. The SRC can be used as an information sharing point for the Wi-Fi and 3GPP networks. Optimal traffic steering can then be performed by considering the situation at each network. Using such an abstraction, even legacy UEs could benefit from Wi-Fi integration. For example, consider a legacy UE that is already connected to a 3GPP network and comes to a Wi-Fi coverage area, while employing the “Wi-Fi-if-coverage” access selection mechanism described above. When the UE tries to connect to the Wi-Fi network, the Wi-Fi AP/AC can connect to the SRC to request information about the current user's Quality of Service (QoS) in the 3GPP network, and if it is found that the user's quality-of-service (QoS) is going to be degraded if the connection is switched to a rejection could be sent to the UE from the Wi-Fi in order keep it connected to the 3GPP network. A tighter integration can also be formed if the Wi-Fi AP and eNB are co-located and have direct communication between them, rather than communicating via the SRC (similarly one can think of direct communication between the AC, RNC, BSS, etc.).

The different deployment scenarios for Wi-Fi can be categorized into three groups as Private Wi-Fi, Public Wi-Fi and Integrated Wi-Fi. These different scenarios are explained below:
Private Wi-Fi (residential, enterprise)
   Access selection controlled by end user
   Operator services supported over the top and/or with S2b (S2c)
   No charging
Public Wi-Fi (3rd Party, Operator/Shared Hotspot)
   Access selection depending on roaming agreements, end user, etc.
   Possible to use HS2.0 mechanism for authentication (EAP-SIM) and roaming
      Access selection based on operator policies, such as those established using Access Network Discovery and Selection Function (ANDSF) or Hot Spot 2.0 (HS2.0) may be supported in the future terminals.
   Operator services supported over the top and/or with S2b (S2c)
   Different charging models typically used in Wi-Fi compared to cellular (e.g. flat-rate, bucket charging).
Integrated Wi-Fi (Wi-Fi as a part of Heterogeneous network)
   Wi-Fi network is managed by the operator.
   Access selection controlled by operator via network based mechanism and/or ANDSF/HS2.0 policies sent to the UE
   Seamless Wi-Fi offloading experience for end user (i.e. user does not need to care about which interfaces are used for the traffic)
   All operator services supported using smart service selection and user plane integration (e.g. S2a, S2b over trusted W-Fi)
   Possibility to optimize network performance and end user experience
   Future support for seamless IP session continuity
   Similar charging model in Wi-Fi and cellular.

For the Private and the Public W-Fi (W-Fi roaming) scenarios it is expected that only limited network control can be used due to, e.g., the different charging models typically used in Wi-Fi compared to cellular. Examples of network control mechanisms that could be also applicable in these scenarios are ANDSF and HS2.0.

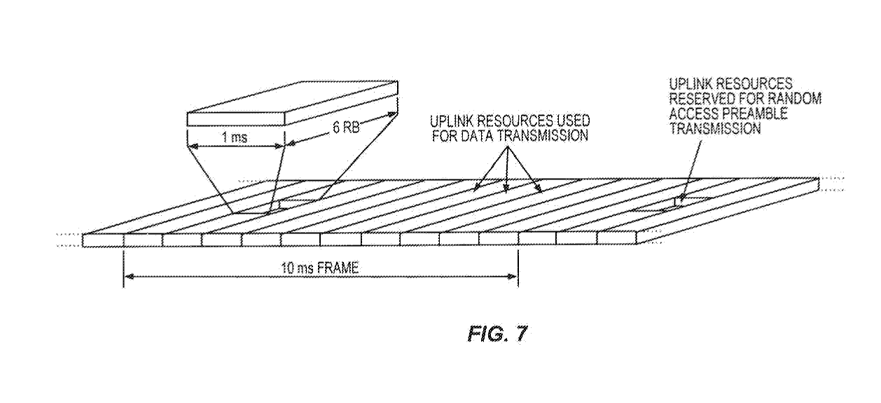

In LTE, as in any mobile communication system, a mobile terminal may need to contact the network (via the eNodeB) without having a dedicated resource in the Uplink (from UE to base station). To handle this, a random access procedure is available, whereby a UE that does not have a dedicated UL resource may transmit a signal to the base station. The first message of this procedure is typically transmitted on a special resource reserved for random access, a physical random access channel (PRACH). This channel can for instance be limited in time and/or frequency (as in LTE). The resources available for PRACH transmission are provided to the terminals as part of the broadcasted system information, or as part of dedicated RRC signaling in case of handover, for example. FIG. 7 illustrates how particular uplink resources are reserved for random access preamble transmissions in an LTE system.

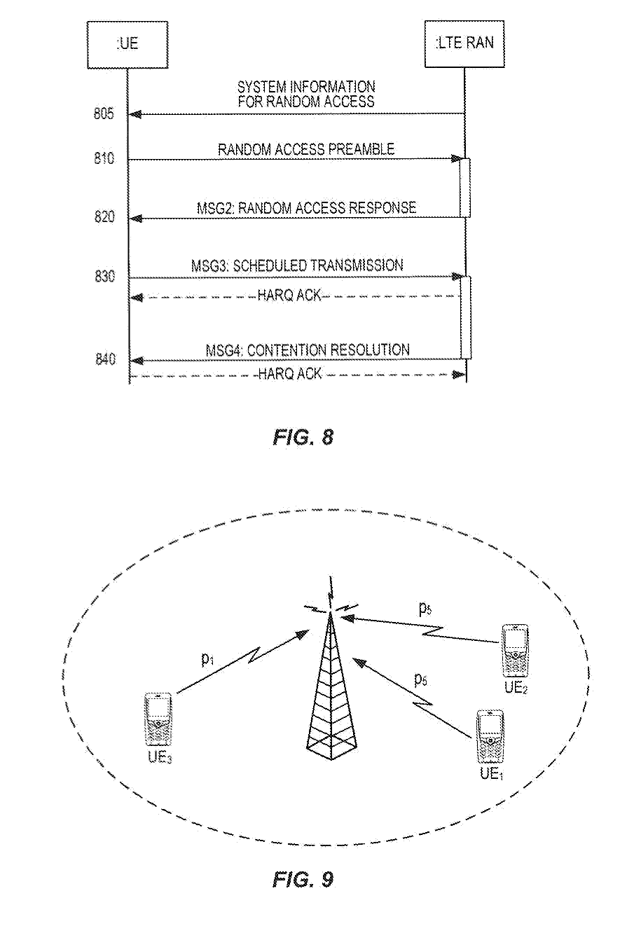

In LTE, the random access procedure can be used for a number of different reasons. Among these reasons are:
Initial access (for UEs in the LTE_IDLE or LTE_DETACHED states)
Incoming handover
Resynchronization of the UL
Scheduling request (for a UE that is not allocated any other resource for contacting the base station)
Positioning
   FIG. 8 illustrates the signaling performed over the air interface for the contention-based random access procedure used in LTE. The UE starts the random access procedure by randomly selecting one of the preambles available for contention-based random access. This selection may be based on system information previously provided to the UE by the RAN, as shown in FIG. 8 at 805. The UE then transmits the selected random access preamble on the physical random access channel (PRACH) to eNode B in the radio access network (RAN), as shown at 810.

The RAN acknowledges any preamble it detects by transmitting a random access response (MSG2), as shown at 820. In the LTE context, this includes an initial grant to be used on the uplink shared channel, a temporary identifier for the mobile terminal (a Cell-Radio Network Temporary Identifier, or C-RNTI), and a time alignment (TA) update based on the timing offset of the preamble measured by the eNodeB on the PRACH. The MSG2 is transmitted in the downlink to the UE and its corresponding Physical Downlink Control Channel (PDCCH) message Cyclic Redundancy Check (CRC) is scrambled with the Random Access-Radio Network Temporary Identifier (RA-RNTI).

After receiving the response, the UE uses the grant to transmit a message MSG3, as shown at 830. The MSG3 is used to trigger the establishment of radio resource control (RRC connection request) and to uniquely identify the UE on the common channels of the cell. The timing alignment command provided in the random access response is applied in the uplink transmission of MSG3. The eNB can change the resources blocks that are assigned for a MSG3 transmission by sending an uplink grant with a CRC that is scrambled with a Temporary Cell-Radio Network Temporary Identifier (TC-RNTI).

The MSG4, which provides contention resolution, is transmitted by the RAN to the UE, as shown at 840. MSG4 has its PDCCH CRC scrambled with the C-RNTI, if the UE previously has a C-RNTI assigned. If the UE does not have a C-RNTI previously assigned, its PDCCH CRC is scrambled with the TC-RNTI.

The procedure thus ends with the RAN solving any preamble contention that may have occurred for the case that multiple UEs transmitted the same preamble at the same time. This can occur, since each UE randomly selects when to transmit and which preamble to use. If multiple UEs select the same preamble for the transmission on RACH, there will be contention between these UEs that needs to be resolved through the contention resolution message (MSG4). A scenario where contention occurs is illustrated in FIG. 9, where two UEs transmit the same preamble, p5, at the same time. A third UE also transmits at the same RACH, but since it transmits with a different preamble, p1, there is no contention between this UE and the other two UEs.

As noted above, more and more terminals are capable of connecting to and obtaining service from both a 3GPP RAT, such as WCDMA and LTE, and a WLAN. In a system where some terminals can connect to WLAN and some terminals cannot (due to differences in capabilities, due to being inside/outside the coverage of a WLAN access point), it is likely to be preferred that the terminals that cannot connect to a WLAN or that are not currently connected to a WLAN should be given priority with respect to accessing the LTE network over the terminals which can connect to a WLAN or that are already connected to a WLAN. This approach may be especially important when the LTE network can only admit a limited number of terminals, for example due to high load.

According to several embodiments of the presently disclosed techniques, a terminal indicates to a first radio access network (RAT) whether the terminal is connected to or is able to connect to a second RAT. The first RAT then takes this into consideration, and may prioritize a terminal indicating that it is not connected to another RAT over a terminal that is connected to another RAT.

It should be noted that while the present techniques are described in the context of terminals able to connect to a wide-area network and a WLAN, the techniques are more generally applicable to terminals supporting multiple radio access technologies (RATs). Thus, according to several embodiments of the presently disclosed techniques, a terminal indicates to one RAN, during a connection attempt to it, its connection status towards another RAN. In the below example embodiments the terminal will indicate to an LTE network its connection status to WLAN either by indicating an establishment cause or by using a certain random access preamble. However, this invention can be applied also to other combinations of RATs as well, e.g., a WiMAX terminal may be configured to indicate to a WiMAX network its connection status towards an UMTS network.

One benefit of these techniques is that the LTE network (for example) can take into consideration the indicated value when performing so-called admittance control, where the network can either admit or reject each terminal's connection attempt. This is beneficial, for example, in the event that the LTE network is highly loaded, in which case the LTE network may not want to admit the terminal if the terminal is connected to WLAN, while if the terminal has no other connection available, the LTE network may prioritize the terminal higher and may therefore admit the terminal. The reasoning for this behavior is that if a terminal has a WLAN connection it is not as urgent that it gets admitted to LTE as it would be if the terminal did not have the WLAN connection. In high load scenarios, this could work as a load balancing between LTE and WLAN.

In the event that the terminal is doing a connection attempt to the LTE network to get a service that is only supported on the LTE network, it may indicate in the access attempt that it has no WLAN connection. One such example service is VoLTE (Voice over LTE), which is not supported over WLAN.

In the case of LTE, the approach described above can be implemented by having the terminal setting the indicator value to the LTE network in a message sent during a random access procedure. This indicator could be included in the RRC connection request message which is sent during a contention based random access procedure, such as the random access procedure illustrated in FIG. 8.

Whether WLAN is available to a terminal may be defined in any of several different ways. Thus, the indicator sent to the network may indicate any of the following, in various embodiments:
Detected WLAN—The indicator sent to the network may indicate whether or not the terminal has detected at least one WLAN network, indicating that the terminal is within the coverage of at least one WLAN network. If the terminal is under the coverage of a WLAN network it can potentially connect to and get served by the WLAN network. In some embodiments, it may be the case that the terminal only indicates that it has detected a WLAN network in the event that the terminal has access rights to at least one WLAN network. In this case, if the terminal has not detected any WLAN network to which the terminal has access rights, the terminal would then not indicate that it has detected any WLAN network. It may also be so that the terminal only indicates that it has detected WLAN in the event that the quality is above a certain level, e.g., measured on received signal strength. This threshold may be signaled from the network to the terminal, e.g., in a broadcasted message or signaled to at an earlier stage when the terminal has been connected to the LTE network.
Connected to WLAN—The indicator sent to the network may indicate whether or not the terminal is connected to a WLAN network, i.e. that the terminal can be served by the WLAN network. It may be so that the terminal only indicates that it is connected to WLAN in case the WLAN connection is good enough or the QoE achieved from the WLAN is good enough, i.e., that the terminal only indicates that WLAN is available for the terminal in the event that the WLAN connection is satisfactory to the terminal. The threshold may be defined on the experienced user throughput, whether the QoS requirements for the terminal is met, whether the delay or latency is short enough, etc.

One possible way for the mobile terminal to send the indicator discussed above to the network is to use a spare value that is otherwise used in a message sent as part of a connection attempt. For example, in the current (Release 11) specification of LTE, there are two spare values of the establishment cause parameter that are unused in the RRC connection request message. Thus, one possible implementation of the techniques described above is that these values are used for the indicator. Thus, the establishment cause parameter sent in the RRC connection request message can be set to a specific value by the terminal to indicate that WLAN is available to the terminal. One example implementation is that one value is reserved for the case when the terminal has detected a WLAN network. A terminal that has detected WLAN should set the establishmentCause to detected-wlan upon RRCConnectionRequest. Another value is reserved for the case when the terminal has connected to a WLAN network; the terminal should set the establishmentCause to connected-wlan if the terminal is connected to a WLAN network upon RRCConnectionRequest.

In another embodiment the UE can set the establishmentCause to a specific value in the event that a particular policy provided to the UE by the WLAN and/or 3GPP network, e.g., the 3GPP RAN or an ANDSF server, has been fulfilled. The term “policy” as used herein may refer to a set of thresholds and/or conditions, along with operations that should be carried out upon their fulfillment. The threshold and conditions may be based on, for example, WLAN and/or 3GPP signal quality, WLAN and/or 3GPP signal strength, WLAN and/or 3GPP load related parameters, etc.

Another way of implementing the present techniques is to divide the random access preambles into different sets. One set of preambles may be used for the case when the terminal has connected to WLAN. If the network receives a preamble from this certain set of preambles it will know that the terminal sending the preamble (and trying to access the LTE network) has connected to a WLAN. Similarly, another set of preambles may be used when the terminal has detected a WLAN. The specific division between the preambles should be coordinated between the terminal and the network, so that there is a common understanding of which preambles indicate the availability or connection status of a WLAN. One way of achieving this is that the network is indicating this preamble division to the terminal, for example in a broadcast message.

The network can reject a terminal's access attempt by not completing the random access procedure, e.g., by not sending MSG4. However, if the timer expires before proper reception of MSG4, then the mobile terminal assumes a radio link failure (RLF). The mobile terminal saves the information regarding the RLF, such as the cell where the failure occurred, etc., and reports this information to the next cell that it successfully connects to, provided it does so within 48 hours. Details of these procedures can be found in section 5.3.3.6 of “Evolved Universal Terrestrial Radio Access (E-UTRA); Radio Resource Control (RRC); Protocol specification RRC specification,” 3GPP TS 36.331, v.11.3.0 (March 2013). This information regarding the RLF is used for setting mobility robustness optimization (MRO) where the failure report statistic can be used to increase or decrease cell selection offsets between the neighbors. To avoid this, an alternative way to reject the terminal could therefore be to indicate the rejection by an indicator in MSG4, or in some other message. One solution to this could also be that the mobile terminal will not trigger RLF in case it has indicated that it has detected/connected to WLAN in the RRCConnectionRequest message. Or, the terminal may trigger RLF but not consider this RLF when reporting to the next cell. Still another alternative is to send a RRC connection redirection message towards WLAN, either during the RRC connection procedure or after the RRC connection has been set up.

Using these techniques, it will be possible for the LTE network to prioritize terminals differently, depending on whether or not they have access to WLAN. As it is less critical that a terminal with access to a WLAN connection gets connected to the LTE network, compared to a terminal having no WLAN connection, it will be beneficial for the system as a whole to admit a terminal having no WLAN connection compared to admitting a terminal having a WLAN connection. This will be especially beneficial if the LTE network is highly loaded.

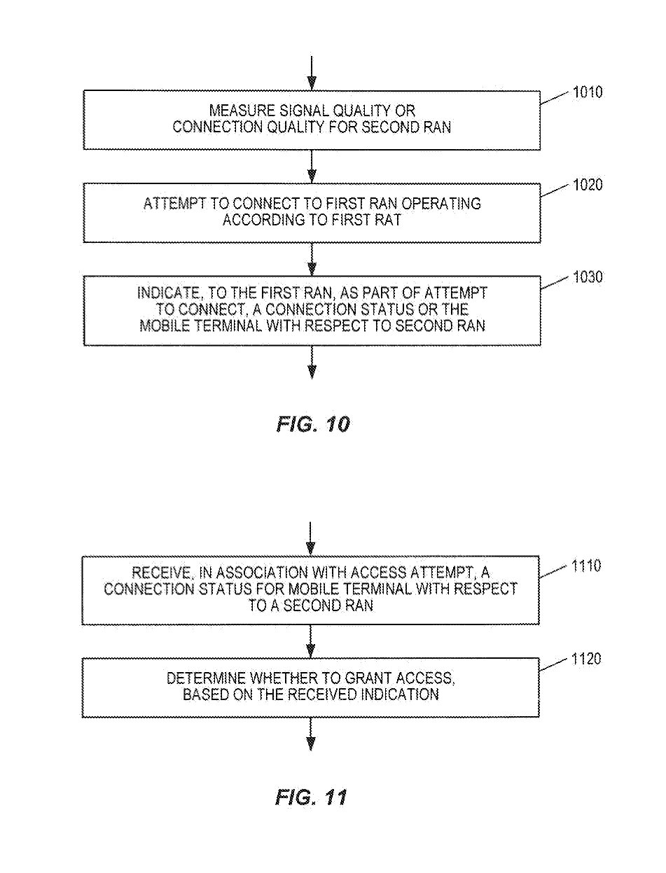

FIG. 10 is a process flow diagram illustrating a method for implementation in a mobile terminal configured to operate according to two or more radio access technologies (RATs). It will be appreciated that the illustrated method is a generalization of the techniques detailed above.

As shown at block 1020, the method includes attempting to connect to a first radio access network (RAN) operating according to a first RAT. This may comprise, for example, a random access attempt, such as an LTE random access attempt as described above. As shown at block 1030, the method further comprises indicating to the first RAN, as part of the connection attempt, a connection status for the mobile terminal with respect to a second RAN operating according to a second RAT. In some embodiments, this indicating comprises indicating whether or not the mobile terminal is connected to the second RAN. In other embodiments, this indicating comprises indicating whether or not the mobile terminal has access rights to connect to the second RAN. In some embodiments, indicating the connection status for the mobile terminal comprises indicating that the mobile terminal has detected the second RAN.

In some embodiments, the method further comprises determining a signal quality or connection quality for the second RAN. This is shown at block 1010. Of course it will appreciated that this operation is “optional” in that it does not appear in all embodiments and/or under all circumstances. When it does, however, indicating the connection status for the mobile terminal with respect to the second RAN may be based on the determined signal quality. More particularly, for example, indicating a connection status for the mobile terminal may indicate that the signal quality or connection quality for the second RAN is above a predetermined threshold, in some embodiments. In some of these embodiments, the indicating of a connection status for the mobile terminal may further indicate that the mobile terminal is connected to the second RAN.

In some embodiments, an establishment cause is sent as part of attempting to connect to the first RAN, the establishment cause indicating the connection status for the mobile terminal with respect to the second RAN. In other embodiments, the mobile terminal selects one of a plurality of random access preambles and sends the selected random access preamble as part of attempting to connect to the first RAN, said random access preamble indicating the connection status for the mobile terminal with respect to the second RAN.

In some embodiments, the mobile terminal determines whether the mobile terminal is attempting to access the first RAN to obtain a service that is not supported on the second RAN, in which case indicating the connection status for the mobile terminal with respect to the second RAN may comprise indicating that no service is available for the second RAN in response to said determining.

In some embodiments, the first radio access network is a cellular telecommunications network, such as a 3GPP LTE network, and the second radio access network is a wireless local area network, such as an IEEE 802.11 wireless network.

FIG. 11 is a process flow diagram illustrating a corresponding method, implemented in a base station or other node of a first radio access network (RAN) operating according to a first radio access technology (RAT). The illustrated method begins, as shown at block 1110, with receiving, in association with a mobile terminal attempting to connect to the first RAN, an indication of a connection status for the mobile terminal with respect to a second RAN operating according to a second RAT. As shown at block 1120, the method continues with determining whether or not to grant the mobile terminal access to the first RAN based on said indication.

In some embodiments, determining whether or not to grant the mobile terminal access to the first RAN comprises prioritizing the mobile terminal for access, based on said indication. In some embodiments or instances, determining whether or not to grant the mobile terminal access to the first RAN comprises rejecting access to the mobile terminal, based on said indication. In some embodiments, rejecting access to the mobile terminal may be further based on a loading condition for the first RAN.

In some embodiments, the received indication indicates whether or not the mobile terminal is connected to the second RAN. In other embodiments, the received indication indicates whether or not the mobile terminal has access rights to connect to the second RAN. In still other embodiments, the indication indicates that the mobile terminal has detected the second RAN.

In some embodiments, the indication comprises an establishment cause sent as part of attempting to connect to the first RAN, said establishment cause indicating the connection status for the mobile terminal with respect to the second RAN. In other embodiments, the indication comprises a selected one of a plurality of random access preambles sent to the first RAN as part of attempting to connect to the first RAN, the selected random access preamble indicating the connection status for the mobile terminal with respect to the second RAN.

In some embodiments, the first radio access network is a cellular telecommunications network, such as a 3GPP LTE network, and the second radio access network is a wireless local area network, such as an IEEE 802.11 wireless network.

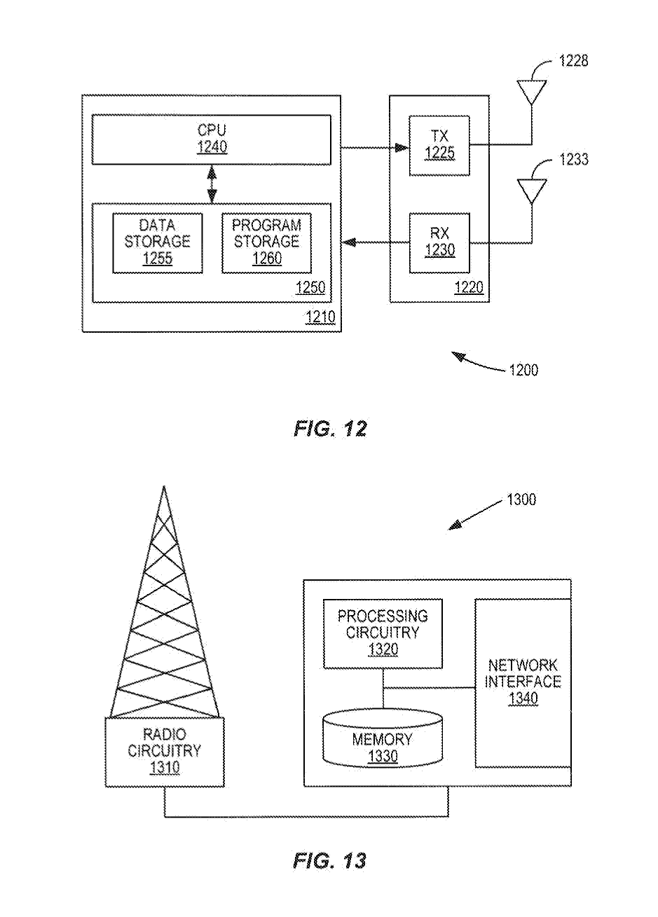

Several of the techniques and methods described above may be implemented using radio circuitry and electronic data processing circuitry provided in a terminal. FIG. 12 illustrates features of an example terminal 1200 according to several embodiments of the present invention. Terminal 1200, which may be a UE configured for operation with an LTE network (E-UTRAN) and that also supports for example, comprises a transceiver unit 1220 for communicating with one or more base stations as well as a processing circuit 1210 for processing the signals transmitted and received by the transceiver unit 1220. Transceiver unit 1220 includes a transmitter 1225 coupled to one or more transmit antennas 1228 and receiver 1230 coupled to one or more receiver antennas 1233. The same antenna(s) 1228 and 1233 may be used for both transmission and reception. Receiver 1230 and transmitter 1225 use known radio processing and signal processing components and techniques, typically according to a particular telecommunications standard such as the 3GPP standards for LTE. Note also that transceiver unit 1220 may comprise separate radio and/or baseband circuitry for each of two or more different types of radio access network, such as radio/baseband circuitry adapted for E-UTRAN access and separate radio/baseband circuitry adapted for WiFi access. The same applies to the antennas—while in some cases one or more antennas may be used for accessing multiple types of networks, in other cases one or more antennas may be specifically adapted to a particular radio access network or networks. Because the various details and engineering tradeoffs associated with the design and implementation of such circuitry are well known and are unnecessary to a full understanding of the invention, additional details are not shown here.

Processing circuit 1210 comprises one or more processors 1240 coupled to one or more memory devices 1250 that make up a data storage memory 1255 and a program storage memory 1260. Processor 1240, identified as CPU 1240 in FIG. 12, may be a microprocessor, microcontroller, or digital signal processor, in some embodiments. More generally, processing circuit 1210 may comprise a processor/firmware combination, or specialized digital hardware, or a combination thereof. Memory 1250 may comprise one or several types of memory such as read-only memory (ROM), random-access memory, cache memory, flash memory devices, optical storage devices, etc. Because terminal 1200 supports multiple radio access networks, processing circuit 1210 may include separate processing resources dedicated to one or several radio access technologies, in some embodiments. Again, because the various details and engineering tradeoffs associated with the design of baseband processing circuitry for mobile devices are well known and are unnecessary to a full understanding of the invention, additional details are not shown here.

Typical functions of the processing circuit 1210 include modulation and coding of transmitted signals and the demodulation and decoding of received signals. In several embodiments of the present invention, processing circuit 1210 is adapted, using suitable program code stored in program storage memory 1260, for example, to carry out one of the techniques described above. Thus, for example, processing circuit 1210 may be adapted, via suitable program code in memory 1260, to attempt to connect to a first radio access network, RAN, operating according to a first RAT, and to indicate to the first RAN, as part of said attempt to connect, a connection status for the mobile terminal apparatus 1200 with respect to a second RAN operating according to a second RAT. Of course, it will be appreciated that not all of the steps of these techniques are necessarily performed in a single microprocessor or even in a single module.

Similarly, several of the techniques and processes described above can be implemented in a network node, such as an eNodeB or other node in a 3GPP network. FIG. 13 is a schematic illustration of a base station apparatus 1300 in which a method embodying any of the presently described network-based techniques can be implemented. Base station apparatus 1300 includes network interface circuit 1340, processing circuitry 1320, a memory 1330, radio circuitry 1310, and at least one antenna. Network interface circuit 1340 is adapted for communication with one or more nodes in a core network of a wireless communication system. The processing circuitry 1320 may comprise RF circuitry and baseband processing circuitry (not shown). In particular embodiments, some or all of the functionality described above as being provided by a base station (e.g., an LTE eNB) may be provided by the processing circuitry 1320 executing instructions stored on a computer-readable medium, such as the memory 1330 shown in FIG. 13. Thus, for example, processing circuit 1320 may be adapted, e.g., with appropriate executable program instructions stored in memory 1330, to receive, in association with a mobile terminal attempting to connect to the first RAN, an indication of a connection status for the mobile terminal with respect to a second RAN operating according to a second RAT, and to determine whether or not to grant the mobile terminal access to the first RAN based on the indication. Alternative embodiments of the network node 1300 may include additional components responsible for providing additional functionality, including any of the functionality identified above and/or any functionality necessary to support the solution described above.

In several embodiments of the present invention, a processing circuit is adapted, using suitable program code stored in memory, for example, to carry out one or more of the techniques described above, including any one of the methods discussed in connection with FIGS. 10 and 11. Of course, it will be appreciated that not all of the steps of these techniques are necessarily performed in a single microprocessor or even in a single module. It will be appreciated that a processing circuit, as adapted with program code stored in memory, can implement the process flow of FIG. 10 or 11, or variants thereof, using an arrangement of functional “modules,” where the modules are computer programs or portions of computer programs executing on the processor circuit. Accordingly, any of the apparatus described above, whether forming all or part of a mobile terminal apparatus or a base station apparatus, can be understood as comprising one or more functional modules implemented with processing circuitry.

Thus, for example, a mobile terminal apparatus may comprise an access attempt module arranged to attempt to connect to a first radio access network (RAN) operating according to a first RAT, as well as an indicator module arranged to indicate to the first RAN, as part of said attempt to connect, a connection status for the mobile terminal apparatus with respect to a second RAN operating according to a second RAT. Likewise, a base station apparatus may comprise a receiving module adapted to receive, in association with a mobile terminal attempting to connect to the first RAN, an indication of a connection status for the mobile terminal with respect to a second RAN operating according to a second RAT, as well as a determining module arranged to determine whether or not to grant the mobile terminal access to the first RAN based on said indication. The mobile terminal apparatus and/or base station apparatus may comprise additional functional modules corresponding to any of the various additional operations described above in connection with FIGS. 10 and 11, for example.

Embodiments of the inventive techniques and apparatus described above include, but are not limited to:
a. A method, in a mobile terminal configured to operate according to two or more radio access technologies (RATs), the method comprising:
attempting to connect to a first radio access network (RAN) operating according to a first RAT; and
as part of said attempting, indicating, to the first RAN, a connection status for the mobile terminal with respect to a second RAN operating according to a second RAT.
   b. The method of example embodiment a, wherein said indicating the connection status for the mobile terminal comprises indicating whether or not the mobile terminal is connected to the second RAN.
   c. The method of example embodiment a, wherein said indicating the connection status for the mobile terminal comprises indicating whether or not the mobile terminal has access rights to connect to the second RAN.
   d. The method of example embodiment a, wherein said indicating the connection status for the mobile terminal comprises indicating that the mobile terminal has detected the second RAN.
   e. The method of any of example embodiments a-d, further comprising determining a signal quality for the second RAN, and wherein said indicating the connection status for the mobile terminal with respect to the second RAN is based on said signal quality.
   f. The method of any of example embodiments a-e, wherein said indicating comprises sending an establishment cause as part of attempting to connect to the first RAN, said establishment cause indicating the connection status for the mobile terminal with respect to the second RAN.
   g. The method of any of example embodiments a-e, wherein said indicating comprises selecting one of a plurality of random access preambles and sending the selected random access preamble as part of attempting to connect to the first RAN, said selected random access preamble indicating the connection status for the mobile terminal with respect to the second RAN.
   h. The method of any of example embodiments a-g, further comprising determining whether the mobile terminal is attempting to access the first RAN to obtain a service that is not supported on the second RAN, wherein said indicating the connection status for the mobile terminal with respect to the second RAN comprises indicating that no service is available for the second RAN in response to said determining.
   i. The method of any of example embodiments a-h, wherein the first radio access network is a cellular telecommunications network and the second radio access network is a wireless local area network.
   j. The method of example embodiment i, wherein the wireless local area network is an IEEE 802.11 network and the cellular telecommunications network is an LTE network.
   k. A method, in a node of a first radio access network (RAN) operating according to a first radio access technology (RAN), the method comprising:
receiving, in association with a mobile terminal attempting to connect to the first RAN, an indication of a connection status for the mobile terminal with respect to a second RAN operating according to a second RAT; and
determining whether or not to grant the mobile terminal access to the first RAN based on said indication.
   l. The method of example embodiment k, wherein determining whether or not to grant the mobile terminal access to the first RAN comprises prioritizing the mobile terminal for access based on said indication.
   m. The method of example embodiment k, wherein determining whether or not to grant the mobile terminal access to the first RAN comprises rejecting access to the mobile terminal, based on said indication.
   n. The method of example embodiment m, wherein said rejecting access to the mobile terminal is further based on a loading condition for the first RAN.
   o. The method of any of example embodiments k-m, wherein said indication indicates whether or not the mobile terminal is connected to the second RAN.
   p. The method of any of example embodiments k-m, wherein said indication indicates whether or not the mobile terminal has access rights to connect to the second RAN.
   q. The method of any of example embodiments k-m, wherein said indication indicates that the mobile terminal has detected the second RAN.
   r. The method of any of example embodiments k-q, wherein said indication comprises an establishment cause as part of attempting to connect to the first RAN, said establishment cause indicating the connection status for the mobile terminal with respect to the second RAN.
   s. The method of any of example embodiments k-q, wherein said indication comprises a selected one of a plurality of random access preambles sent to the first RAN as part of attempting to connect to the first RAN, said selected random access preamble indicating the connection status for the mobile terminal with respect to the second RAN.
   t. The method of any of example embodiments k-q, wherein the first radio access network is a cellular telecommunications network and the second radio access network is a wireless local area network.
   u. The method of example embodiment t, wherein the wireless local area network is an IEEE 802.11 network and the cellular telecommunications network is an LTE network.
   v. A mobile terminal apparatus comprising:
radio circuitry adapted to handle connections to two radio access technologies (RATs) and
a processing circuit adapted to:
   attempt to connect to a first radio access network (RAN) operating according to a first RAT; and
   indicate to the first RAN, as part of said attempt to connect, a connection status for the mobile terminal with respect to a second RAN operating according to a second RAT.
      w. The mobile terminal apparatus of example embodiment v, wherein the processing circuit is adapted to indicate the connection status for the mobile terminal by indicating whether or not the mobile terminal is connected to the second RAN.
      x. The mobile terminal apparatus of example embodiment v, wherein the processing circuit is adapted to indicate the connection status for the mobile terminal by indicating whether or not the mobile terminal has access rights to connect to the second RAN.
      y. The mobile terminal apparatus of example embodiment v, wherein the processing circuit is adapted to indicate the connection status for the mobile terminal by indicating that the mobile terminal has detected the second RAN.
      z. The mobile terminal apparatus of any of example embodiments v-y, wherein the processing circuit is further adapted to determine a signal quality for the second RAN and to indicate the connection status for the mobile terminal with respect to the second RAN based on said signal quality.
      aa. The mobile terminal apparatus of any of example embodiments v-z, wherein the processing circuit is adapted to indicate the connection status by sending an establishment cause as part of attempting to connect to the first RAN, said establishment cause indicating the connection status for the mobile terminal with respect to the second RAN.
      bb. The mobile terminal apparatus of any of example embodiments v-z, wherein the processing circuit is adapted to indicate the connection status by selecting one of a plurality of random access preambles and sending the selected random access preamble as part of attempting to connect to the first RAN, said selected random access preamble indicating the connection status for the mobile terminal with respect to the second RAN.
      cc. The mobile terminal apparatus of any of example embodiments v-bb, wherein the processing circuit is further adapted to determine whether the mobile terminal is attempting to access the first RAN to obtain a service that is not supported on the second RAN, and to indicate to the first RAN that no service is available for the second RAN in response to said determining.
      dd. A base station apparatus adapted for use in a first radio access network (RAN) according to a first radio access technology (RAT), the base station apparatus comprising:
radio circuitry adapted to handle connections to one or more mobile terminals according to the first radio access technology and
a processing circuit adapted to:
   receive, in association with a mobile terminal attempting to connect to the first RAN, an indication of a connection status for the mobile terminal with respect to a second RAN operating according to a second RAT; and
   determine whether or not to grant the mobile terminal access to the first RAN based on said indication.
      ee. The base station apparatus of example embodiment dd, wherein the processing circuit is adapted to prioritize the mobile terminal for access, based on said indication.
      ff. The base station apparatus of example embodiment dd or ee, wherein the processing circuit is adapted to determine whether or not to grant the mobile terminal access to the first RAN is based further on a loading condition for the first RAN.
      gg. The base station apparatus of any of example embodiments dd-ff, wherein said indication comprises an establishment cause as part of attempting to connect to the first RAN, said establishment cause indicating the connection status for the mobile terminal with respect to the second RAN.
      hh. The base station apparatus of any of example embodiments dd-ff, wherein said indication comprises a selected one of a plurality of random access preambles sent to the first RAN as part of attempting to connect to the first RAN, said selected random access preamble indicating the connection status for the mobile terminal with respect to the second RAN.

It will be appreciated by the person of skill in the art that various modifications may be made to the above described embodiments without departing from the scope of the present invention. For example, although embodiments of the present invention have been described with examples that include a communication system compliant to the 3GPP specified LTE standard specification, it should be noted that the solutions presented may be equally well applicable to any other 3GPP specified technology in combination with 802.11 specifications. The specific embodiments described above should therefore be considered exemplary rather than limiting the scope of the invention. Because it is not possible, of course, to describe every conceivable combination of components or techniques, those skilled in the art will appreciate that the present invention can be implemented in other ways than those specifically set forth herein, without departing from essential characteristics of the invention. The present embodiments are thus to be considered in all respects as illustrative and not restrictive.

1-40. (canceled)

41. A method, in a mobile terminal configured to operate according to two or more radio access technologies (RATs) the method comprising:
attempting to connect to a first radio access network (RAN) operating according to a first RAT; and
as part of said attempting, indicating, to the first RAN, a connection status for the mobile terminal with respect to a second RAN operating according to a second RAT.

42. The method of claim 41, wherein indicating the connection status for the mobile terminal comprises indicating whether or not the mobile terminal is connected to the second RAN.

43. The method of claim 41, wherein indicating the connection status for the mobile terminal comprises indicating whether or not the mobile terminal has access rights to connect to the second RAN.

44. The method of claim 41, wherein indicating the connection status for the mobile terminal comprises indicating that the mobile terminal has detected the second RAN.

45. The method of claim 41, wherein indicating the connection status for the mobile terminal comprises sending an establishment cause as part of attempting to connect to the first RAN, said establishment cause indicating the connection status for the mobile terminal with respect to the second RAN.

46. The method of claim 41, wherein indicating the connection status for the mobile terminal comprises selecting one of a plurality of random access preambles and sending the selected random access preamble as part of attempting to connect to the first RAN, said selected random access preamble indicating the connection status for the mobile terminal with respect to the second RAN.

47. The method of claim 41, further comprising determining that the mobile terminal is attempting to access the first RAN to obtain a service that is not supported on the second RAN, and wherein indicating the connection status for the mobile terminal comprises indicating that the mobile terminal is not connected to the second RAN.

48. A mobile terminal apparatus comprising:
radio circuitry adapted to handle connections to two radio access technologies (RATs) and
a processing circuit adapted to:
attempt to connect to a first radio access network (RAN) operating according to a first RAT; and,
indicate to the first RAN, as part of said attempt to connect, a connection status for the mobile terminal apparatus with respect to a second RAN operating according to a second RAT.

49. The mobile terminal apparatus of claim 48, wherein the processing circuit is adapted to indicate the connection status for the mobile terminal apparatus by indicating whether or not the mobile terminal apparatus is connected to the second RAN.

50. The mobile terminal apparatus of claim 48, wherein the processing circuit is adapted to indicate the connection status for the mobile terminal apparatus by indicating whether or not the mobile terminal apparatus has access rights to connect to the second RAN.

51. The mobile terminal apparatus of claim 48, wherein the processing circuit is adapted to indicate the connection status for the mobile terminal apparatus by indicating that the mobile terminal apparatus has detected the second RAN.

52. The mobile terminal apparatus of claim 48, wherein the processing circuit is further adapted to measure a signal quality, or connection quality, for the second RAN and to indicate the connection status for the mobile terminal apparatus based on said signal quality or connection quality.

53. The mobile terminal apparatus of claim 52, wherein the processing circuit is adapted to indicate the connection status for the mobile terminal apparatus in response to determining that the signal quality or connection quality for the second RAN is above a predetermined threshold.

54. The mobile terminal apparatus of claim 53, wherein the processing circuit is adapted to indicate the connection status for the mobile terminal apparatus further in response to determining that the mobile terminal apparatus is connected to the second RAN.

55. The mobile terminal apparatus of claim 48, wherein the processing circuit is adapted to indicate the connection status for the mobile terminal apparatus by sending an establishment cause as part of attempting to connect to the first RAN, said establishment cause indicating the connection status for the mobile terminal apparatus with respect to the second RAN.

56. The mobile terminal apparatus of claim 48, wherein the processing circuit is adapted to indicate the connection status for the mobile terminal apparatus by selecting one of a plurality of random access preambles and sending the selected random access preamble as part of attempting to connect to the first RAN, said selected random access preamble indicating the connection status for the mobile terminal apparatus with respect to the second RAN.

57. The mobile terminal apparatus of claim 48, wherein the processing circuit is further adapted to determine whether the mobile terminal apparatus is attempting to access the first RAN to obtain a service that is not supported on the second RAN, and to indicate to the first RAN that the mobile terminal apparatus is not connected to the second RAN, in response to said determining.

58. A base station apparatus adapted for use in a first radio access network (RAN) according to a first radio access technology (RAT) the base station apparatus comprising:
radio circuitry adapted to handle connections to one or more mobile terminals according to the first radio access technology and
a processing circuit adapted to:
receive, in association with a mobile terminal attempting to connect to the first RAN, an indication of a connection status for the mobile terminal with respect to a second RAN operating according to a second RAT; and
determine whether or not to grant the mobile terminal access to the first RAN based on said indication.

59. The base station apparatus of claim 58, wherein the processing circuit is adapted to prioritize the mobile terminal for access, based on said indication.

60. The base station apparatus of claim 58, wherein the processing circuit is adapted to determine whether or not to grant the mobile terminal access to the first RAN is based further on a loading condition for the first RAN.

61. The base station apparatus of claim 58, wherein said indication comprises an establishment cause as part of attempting to connect to the first RAN, said establishment cause indicating the connection status for the mobile terminal with respect to the second RAN.

62. The base station apparatus of claim 58, wherein said indication comprises a selected one of a plurality of random access preambles sent to the first RAN as part of attempting to connect to the first RAN, said selected random access preamble indicating the connection status for the mobile terminal with respect to the second RAN.
